(19) United States
(12) Patent Application Publication
(10) Pub. No.: US 2026/0340261 A1
(43) Pub. Date: Oct. 29, 2026

(54) LLM-BASED DATA INGESTION

(71) Applicant: SAP SE, Walldorf (DE)

(72) Inventor: Manikandan RAJASEKAR, Bangalore (IN)

(21) Appl. No.: 19/192,755

(22) Filed: Apr. 29, 2025

(51) Int. Cl. G06F 40/151; G06F 16/383

(52) U.S. Cl. CPC G06F 40/151; G06F 16/383

(57) ABSTRACT

Systems and methods include reception of document extraction results from a document processing service, prompting of a first text generation model to identify one of a plurality of document processing scenarios based on the document extraction results and on embeddings representing each of the plurality of document processing scenarios, prompting of a second text generation model to transform the document extraction results to a target schema of the identified document processing scenario, prompting of a third text generation model to convert the transformed document extraction results to a semantic object of the identified document processing scenario, and calling of an application programming interface of an application to transmit the semantic object to the application.

### BACKGROUND

Modern database systems store vast amounts of data for their respective enterprises. Software applications are employed to access this stored data in order to perform various functions. These functions are increasingly provided via integration with neural networks, or machine learning models. The machine learning models may include, for example, custom models trained on private data or publicly-available Large Language Models (LLMs). By leveraging the predictive algorithms of these models, a software application may suggest inputs, predict numerical and/or textual values, generate summaries, descriptions, reports and emails, and recommend next steps or actions.

Enterprises receive and generate significant amounts of unstructured data, such as emails, images, physical documents and digital documents. Software applications may attempt to integrate such unstructured data into enterprise functions. Often such integration includes the generation of structured data from the unstructured data. It has been considered to generate structured data from unstructured data by leveraging document processing services offered by various hyperscaler and custom ML models.

Because different software applications have distinct document processing needs, logic, and operational workflow, each application must be independently tailored to integrate with a document processing services. This integration requires significant development resources to enable seamless communication between the application and the document processing service, to adapt to lifecycle events such as changes to the document processing service or updates to the underlying data model. These difficulties are multiplied if integration with multiple document processing services is desired.

Enterprise users typically access several available applications, some of which require users to upload images, digital documents, and email-based documents. No standardized approach exists for uploading, processing and ingesting such documents across varied applications. This lack of uniformity complicates the user experience. Moreover, considerable effort must be expended to maintain document processing configurations and customizations within each of the applications.

Systems are desired to facilitate the ingestion of structured data from unstructured documents using various document processing services.

### BRIEF DESCRIPTION OF THE DRAWINGS

FIG. 1 is a block diagram of an architecture to facilitate ingesting of structured data from unstructured documents using various document processing services according to some embodiments.

FIG. 2 is a detailed block diagram of a document processor to serve requests for structured data extracted from unstructured documents according to some embodiments.

FIG. 3 is a diagram of a schema of according to some embodiments.

FIG. 4 is a flow diagram of a process to ingest structured data from unstructured documents according to some embodiments.

FIG. 5 is a block diagram of a cloud-based system providing structured data extracted from unstructured documents according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Some embodiments provide a framework for integrating document processing services with software applications, relieving the need for the software applications to build their own integrations. The framework manages each integration based on inputs and metadata provided by the application and which conform to a generic schema, thereby enhancing flexibility across various document processing services. Embodiments effectively conceal the inherent complexity of document processing integrations while supporting customization and configuration processes for seamlessly managing these integrations.

Briefly, document extraction results received from a document processing service are analyzed to identify a document type. The type is matched with a relevant scenario and the extracted values are mapped to a target schema of the scenario. The mapped values are converted from the target schema to a semantic object conforming to a schema of an application. The semantic object may then be transmitted to the application for processing, storage, etc.

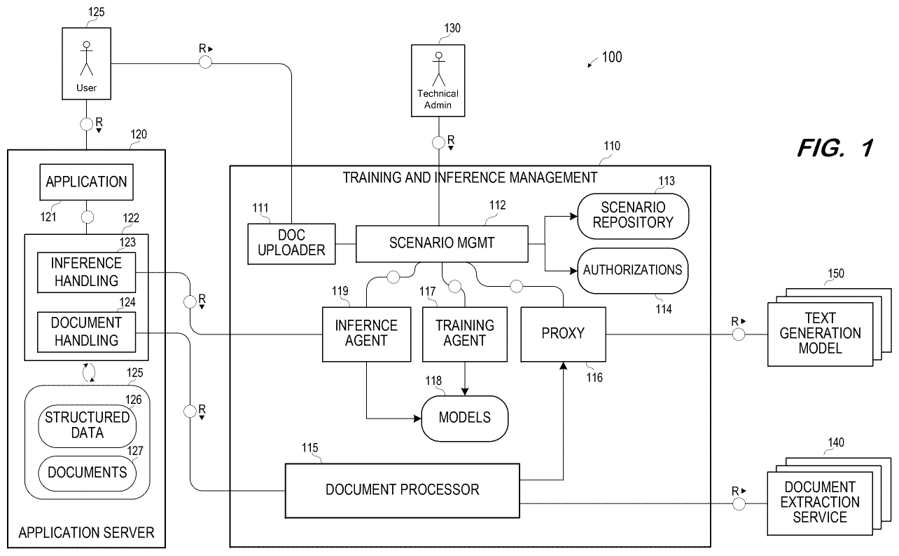

FIG. 1 is a block diagram of an architecture to facilitate ingesting of structured data from unstructured data according to some embodiments. The illustrated elements of system 100 may be implemented using any suitable combination of computing hardware and/or software that is or becomes known. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service). Such implementations apportion computing resources elastically according to demand, need, price, and/or any other metric.

Each component described herein may be executed by one or more physical and/or virtualized servers. In particular, each execution environment depicted herein may comprise one or more physical servers, virtual machines, clusters of a container orchestration system, or other implementation providing an operating system, services, I/O, storage, libraries, frameworks, etc. to applications executing therein. For example, application server 120 is an execution environment which may comprise an on-premise or cloud-based server providing an execution platform and services to applications such as application 121.

Application 121 may comprise an application providing functions to users based on coded logic and stored data (not shown) as is known in the art. The application logic may create, read, update and delete data of datastore 125 based on a data schema consisting of semantic objects as is known in the art. Datastore 125 may comprise any suitable storage system such as a database system, which may be partially or fully remote from application server 120. Structured data 126 may comprise relational database tables and views whose columns conform to a data schema defined by metadata. Application 121 may comprise a single-tenant or multi-tenant application.

A user 128 may operate a user device (not shown) to interact with application 121. A user device may comprise but is not limited to a laptop computer, a desktop computer, a smartphone, and a tablet computer. A user device may include one or more processing units to execute program code of a Web browser or another application providing user interfaces for interacting with application 121. The user interface may comprise a front-end user interface application corresponding to application 121 and which executes within a virtual machine of a Web browser to communicate with application 121 and present user interfaces thereof.

Training and inference management service 110 includes scenario management component 112 and scenario repository 113. Scenario management component 112 allows technical administrator (e.g., a key user) 130 to define and modify scenarios stored in scenario repository 113. A scenario may specify a document processing service, a document type, metadata, and a semantic object. Scenario management component 112 may also associate a scenario with an application in order to enable application end-users to perform document processing based on the scenario. Scenario management component 112 also uses authorizations 114 to manage secure access to scenarios and document processing services by applications and/or users.

In some embodiments, scenario management component 112 may receive and respond to machine learning-related requests from technical administrator 130. The requests may comprise requests to define a machine learning-related scenario, to train a model using a machine learning-related scenario, and to deploy a machine learning-related scenario and trained model to models 118 for use by application 121 executing on application server 120. According to some embodiments, a machine learning-related scenario may specify a “classical” model (e.g., a classification model, a regression model), training data, validation data, a training pipeline, and an inference pipeline. Two or more machine learning-related scenarios may share the same model, data and/or pipeline.

Scenario management component 112 may also receive requests from application 121, via inference handling component 123, to perform an inference using a machine learning-related scenario based on an object instance of structured data 126. In response, inference agent 119 identifies a trained model 118 corresponding to the machine learning-related scenario and inputs the data to the trained model to generate an output. The output is then returned to inference handling component 123.

Inference handling component 123 may comprise a component of library 122 provided to a developer of application 121. Inference handling component 123 communicates with inference agent 119 via remote APIs exposed by component 110 based on instructions received from application 121. Inference handling component 123 may be updated in response to updates to the remote APIs without changing the interface exposed to application 121, such that application 121 need not be updated in this event. To improve reliability, inference handling component 123 may incorporate retry mechanisms, timeout handling, and failover protocols.

Document processor 115 processes unstructured documents uploaded through various channels. For example, user 128 may upload a document directly to application 121. Application 121 calls document handling component 124 to pass the document to document processor 115. Document handling component 124 may also comprise a component of library 122 which communicates with document processor 115 via remote APIs exposed by component 110. User 128 may also upload documents by accessing document uploader 111 of management component 110. In yet another example, a document may be uploaded to one of document extraction services 140. The document is processed by the document extraction service 140 and the extraction results are provided to document processor 115 for further processing as described herein.

Document extraction services 140 provide document extraction results and may be provided by various service providers. Document processor 115 utilizes text generation models 150 (via proxy 116) as described herein to process the extraction results and provide structured data to application 121 in a manner which conforms to the data schema of structured data 126. The results are thereby readily usable for application processes.

Each of text generation models 150 may comprise a neural network trained to generate text based on input text. A text generation model 150 may be implemented by, for example, executable program code, a set of hyperparameters defining a model structure and a set of corresponding weights, or any other representation of an input-to-output mapping which was learned as a result of the training. According to some embodiments, each text generation model 150 is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of text generation models 150 include GPT-4, LaMDA, Claude or the like. Models 150 may be publicly available or deployed within a landscape which is trusted by a provider of application server 120. Similarly, text generation models 150 may be trained based on public and/or private data.

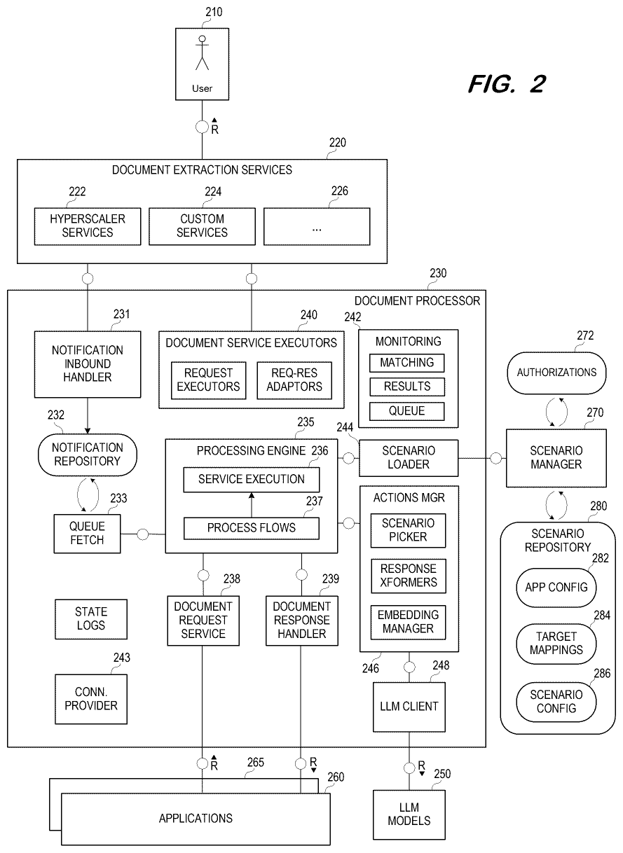

FIG. 2 is a detailed block diagram of a system to serve requests for structured data extracted from unstructured documents according to some embodiments.

Document processor 230 may comprise an implementation of document processor 115 of FIG. 1, but embodiments are not limited thereto. Document processor 230 manages document uploads and utilizes extraction services 220 to extract diverse types of information from the documents and return the results to an application 260, 265 in a schema-based response. Document processor 230 thereby ensures that the extracted data is accurately formatted and readily usable for further application processes.

Document extraction services 220 may include Hyperscaler services 222, custom services 224 and other services 226. Hyperscaler services 222 may be provided by cloud service providers such as AWS or Azure. Hyperscaler services 222 may offer scalable and robust document extraction capabilities leveraging advanced AI techniques. Custom services 224 include custom-built or third-party services that are tailored to specific needs. Services 224 may also provide document extraction capabilities using various AI methodologies.

Document services executors 240 are responsible for downloading document extraction results and monitoring requests to document extraction services 220. Document services executors 240 include a built-in set of adaptors to ensures that the request and response schemas are properly managed. Monitoring component 242 provides a user interface for monitoring the processing of various documents handled by different services and applications. Component 242 offers detailed views of each step in the processing workflow. The monitoring interface allows administrators to track the progress of specific documents during their conversion to semantic objects. For large processing events, monitoring component 242 includes queue management capabilities to handle and manage document processing loads.

Each document processing request initiates a process within processing engine 235. Connectivity provider 243 is responsible for managing communication and directing details to the appropriate document services and application instances. Connectivity provider 243 securely stores authentication details for both inbound and outbound interactions, ensuring that all communication channels are properly authenticated and managed.

Document request service 238 exposes a REST service to applications 260, 265 and extensions, enabling them to invoke document uploads and request processing. Service 238 facilitates integration by providing applications 260, 265 and extensions with a standardized interface for initiating document handling and processing tasks. Document response handler 239 invokes services exposed by applications 260, 265 via Open APIs or dedicated service APIs to post the processed document results. Handler 239 may support direct execution of CREATE and UPDATE APIs (e.g., OData) of applications 260, 265, enabling the structured data generated by the present embodiments to be populated directly into the structured data of applications 260, 265. This direct execution eliminates the need for customized data processing and integration logic within applications 260, 265.

Actions manager 246 coordinates a set of document processing actions, each of which uses specific prompting capabilities to perform distinct tasks. The tasks include scenario selection, scenario integration, and schema transformation. The tasks require interaction with LLM client 248, which manages communication between actions manager 246 and a selected LLM model 250. For example, the scenario picker prompts an LLM to select an appropriate scenario based on scenario metadata and document metadata. The response transformer prompts an LLM to transform extracted document results into a structured schema suitable for a specified semantic object (e.g., a CDS view). The embedding manager generates embeddings of a target mapping and a schema mapping for inclusion into the LLM prompts.

Scenario loader 244 loads scenarios from scenario repository 280 into document processor 230. Scenario loader 244 ensures that newly-stored scenarios are identified and synchronized with document processor 230.

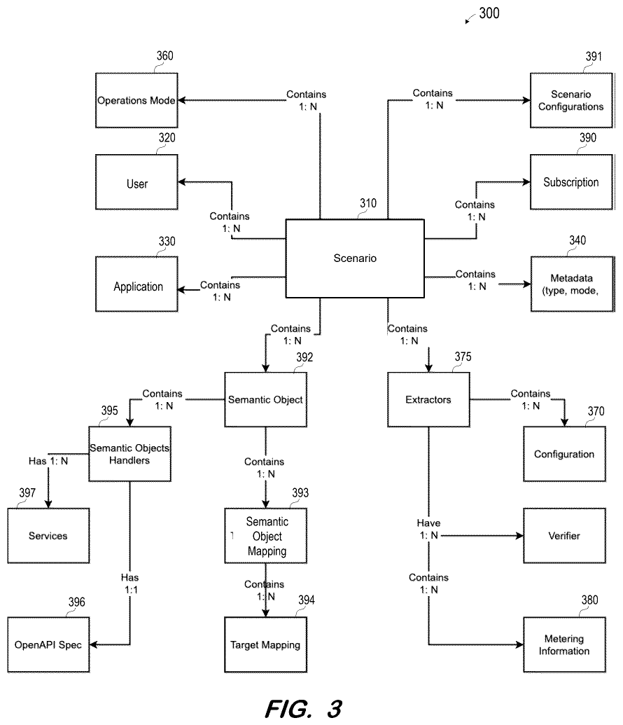

FIG. 3 shows modelling diagram 300 relating to document processing scenarios according to some embodiments. Diagram 300 includes scenario entity 310 representing a scenario and illustrates its references to and relationships with other entities.

A metadata entity 340 may specify a version number, a type, and a name of a scenario. A metadata entity 340 may specify a component or components that provide support for the scenario and a technology type supported by the scenario. Configuration entity 350 the configuration settings specific to a scenario, such as associated document extension type, any specific streaming mechanism to be used for document uploads, and automation settings for mapping extracted results to the schema. The automation settings may indicate how to map extracted data to the schema, required confidence levels for mapping accuracy.

Operations mode entity 360 defines various modes of operation to handle specific patterns required for different scenarios The patterns may include uploading of documents to a document extraction service, uploading of documents directly to an interface of document processor 230, and document uploads through the user interface of an application into which a corresponding semantic object is to be stored.

Extractor configuration 370 details information specific to how each specified extractor 375 should be applied, along with the metering information 380. The information may specify a default extraction mode, any safety filters that should be applied during extraction to ensure data accuracy and security, including mechanisms to prevent the processing of potentially harmful or irrelevant data. Configuration 370 may also describe protocols for securely handling sensitive content during extraction, procedures to be followed in the event of a failure during the extraction process, including backup mechanisms and recovery steps, a wait time or conditions under which documents are held before processing, and the types of metering data to be collected during document processing. Metering data may include metrics on processing times, success rates, and other performance indicators to monitor and optimize the extraction process.

Application entity 330 describes applications associated with a scenario. Application entity 330 includes the name of an application, the types of documents that the application handles, the components that support the application's functionality within this scenario, a unique identifier for the application or document type, and details regarding the origin support requested by the application, specifying any particular requirements or restrictions.

Subscription 390 defines the types of documents or events to which a scenario subscribes. The metadata extracted from documents describes potential document types. These document types are matched against the subscription criteria to route the extraction results to the appropriate scenario. Scenario configurations 391 specify whether the system should automatically match and push document results based on the predefined criteria, the thresholds for confidence levels required to process and route the document results, whether a review process (e.g., additional user confirmation) is necessary to ensure accuracy before final processing.

User entity 320 provides configurations for handling user identity information during document processing. User entity 320 may indicate whether user identity information is carried through the document processing and service update calls to applications, origins from which the user identity information should be accepted, any specific scoping required for document handling as per the scenario, and user attributes to capture as part of the handling process.

Semantic object 392 defines a semantic object, such as CDS views or corresponding table views, related to the scenario. Semantic object 392 includes an identifier for the semantic object and a name of the semantic object. Semantic object mapping 393 enables direct creation of an instance of the semantic object from document extraction results. Each semantic object mapping 393 is associated with a target mapping 394 including a list of mappings from extracted fields to specific columns in the semantic object. The application associated with the semantic object may provide the mappings in a JSON structure. An example target mapping 394 according to some embodiments is as follows:

```
{
  “SemanticObject”: {
    “name” : “CDS_SALES_ORDER”,
    “fieldMapping” :[
      {
      “fieldName”: “SALES_ORDER_ID”,
      “dataType”:“STRING”,
      “validation”: “\hat{ }(?=.*S)[A-Za-z0-9]{10}$”,
      “Labels”: [ “sales order id, order id, order reference, order
      no”],
      “match”: “contains”, “level”: 90,
      “mandatory”: true
  }, {
      “fieldName”: “SALES_ORDER_CREATION”,
      “dataType”:“DATETIME”,
      “validation”: “\hat{ }\d{4}-\d{2}-\d{2}\d{2}:d{2}\:
      \d{2}$”,
      “Labels”: [“Order date, date”],
      “predict”: true,
      “predictStrategy”:“layoutbased”,
      “match”: “contains”,
      “level”: 90, “mandatory”:
      true
      }
      ]
    }
  }
```

Semantic objects handlers 395 allow scenario owners to specify the service APIs to be invoked for uploading the extracted and mapped data to an application. The handler definitions include authorization models, scope requirements, and indications of whether the APIs follow OpenAPI specification 396, custom REST APIs, or services 397 with remote capabilities.

Appendix A provides an example of an instance of scenario entity 310 according to some embodiments, conforming to the schema of diagram 300.

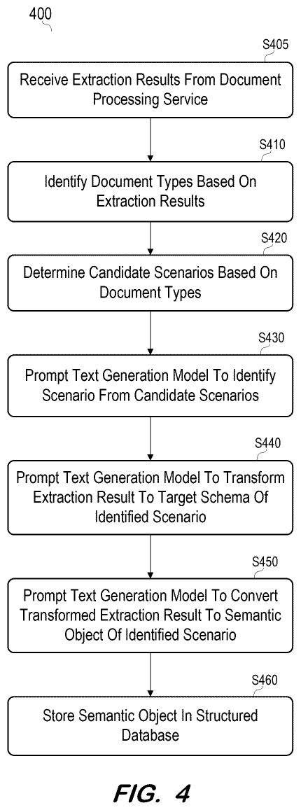

FIG. 4 comprises a flow diagram of process 500 to ingest structured data from unstructured documents according to some embodiments. Process 400 and all other processes mentioned herein may be embodied in processor-executable program code read from one or more of non-transitory computer-readable media, such as a hard disk drive, a volatile or non-volatile random-access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S405, extraction results are received from a document processing service. As mentioned above, the extraction results may be received in any number of manners. In one example, a user uploads a document to a document extraction service using an interface of the document extraction service. The document extraction service processes the document and pushes the extraction results to a document processor such as document processor 230. In another example, a user uploads the document to a document processor via an enterprise application or a user interface of the document processor. In response, the document processor requests document extraction from a document extraction service. Uploading the document may include specifying the document extraction service or a scenario which in turn specifies the document extraction service.

The following is an example of extraction results which may be received from a document processing service according to some embodiments.

```
{
  “sales_order_id”: “SO12345”,
  “customer_details”: {
    “customer_id”: “CUST67890”,
    “name”: “John Doe Enterprises”,
    “address”: {
    “street”: “123 Main Street”,
    “city”: “Metropolis”,
    “state”: “NY”,
    “postal_code”: “10001”,
    “country”: “USA”
    },
    “contact”: {
    “email”: “contact@johndoeenterprises.com”,
    “phone”: “+1-800-555-1234”,
    “fax”: “+1-800-555-5678”,
    “alternate_contact”: {
      “name”: “Jane Smith”,
      “email”: “jsmith@johndoeenterprises.com”,
      “phone”: “+1-800-555-8765”
    }
    }
  },
  “order_details”: {
    “order_date”: “2024-12-19”,
    “delivery_date”: “2024-12-25”,
    “payment_terms”: “Net 30”,
    “currency”: “USD”,
    “discounts”: [
    {
      “type”: “Promotional”,
      “amount”: 50.00
    },
    {
      “type”: “Bulk Purchase”,
      “amount”: 25.00
    }
    ],
    “sub_total”: 1520.75,
    “tax_rate”: 0.07,
    “tax_amount”: 106.45,
    “shipping_cost”: 15.00,
    “total_amount”: 1612.20
  },
  “items”: [
    {
    “item_id”: “ITEM001”,
    “description”: “High-Performance Laptop”,
    “quantity”: 2,
    “unit_price”: 750.00,
    “total_price”: 1500.00,
    “attributes”: {
      “brand”: “TechCorp”,
      “model”: “X200”,
      “warranty”: “2 years”
    }
    },
    {
    “item_id”: “ITEM002”,
    “description”: “USB-C Adapter”,
    “quantity”: 1,
    “unit_price”: 20.75,
    “total_price”: 20.75,
    “attributes”: {
      “color”: “Black”,
      “compatibility”: “Universal”
    }
    }
  ],
  “shipping_details”: {
    “method”: “Express Delivery”,
    “cost”: 15.00,
    “tracking_number”: “TRACK1234567890”,
    “warehouse_location”: {
    “warehouse_id”: “WH001”,
    “address”: {
      “street”: “500 Logistics Lane”,
      “city”: “Hubtown”,
      “state”: “IL”,
      “postal_code”: “62704”,
      “country”: “USA”
    }
    }
  },
  “additional_information”: {
    “special_instructions”: “Handle with care. Deliver during business
    hours only.”,
    “order_priority”: “High”,
    “internal_notes”: “Customer requested expedited handling due to
    end-of-year deadlines.”
  },
  “notes”: “Please confirm receipt of the order and estimated delivery
  time.”
  }
```

Document types are identified based on the extraction results at S410. The identification may be based on keyword matching the extraction results against a list of document types. According to some embodiments, S410 includes prompting an LLM to determine document types from the extraction results. Appendix B provides an example of a prompt template which may be employed in some embodiments of S410. A JSON result of determined document types which may be returned from an LLM in response to a prompt is shown below:

```
{
  “overview”: {
  “confidence”: “95”
  },
  “details”: {
  “documentType”: “sales order request”
  }
}
```

Next, at S420, candidate scenarios are determined based on the identified document types. The candidate scenarios may be determined by keyword matching of metadata 340 associated with stored scenarios against the identified document types. A text generation model is then prompted at S430 to identify a scenario from the candidate scenarios. The prompt used at S430 may instruct an LLM to identify a target mapping 394 based on the extraction results. The prompt may include embeddings representing each of the target mappings. As is known in the art, an embedding is a multi-dimensional numerical vector generated from text and which represents the semantic meaning of the text. Two texts having similar meaning should be closer to one another in vector space than two texts having dissimilar meanings. The embeddings of the target mappings may be generated by inputting the target mappings into an embedding model.

The prompt may instruct the LLM to determine confidence levels, coverage levels and matching field counts between the extraction results and the target mappings of each candidate scenario, and choosing one candidate scenario based on the confidence level, coverage level and matching field count determined for its associated mapping. Appendix C provides an example of a prompt which may be employed in some embodiments of S430.

A text generation model (which may differ from the text generation model used at S430) is prompted at S440 to transform the extraction result to a target schema of the scenario identified at S430. In particular, the model may be prompted to convert the extraction result into a JSON file mapped to the target schema of the scenario. Appendix D provides an example of a prompt which may be employed in some embodiments of S440. The foregoing is an example of conversion of an extraction result into a JSON file mapped to the target schema of a scenario:

```
{
  “overview”: {
  “noOfFieldsSchemaJson”: 8,
  “noOfFieldsResultJson”: 14 (excluding nested objects),
  “noOfMatchingFields”: 7,
  “confidence”: 87.5,
  “coverage”: 0.875,
  “missingFieldCount”: 1
  },
  “details”: {
  “field_from_Schema”: “field_from_result”: [
    “SALES_ORDER_ID”: “sales_order_id”,
    “CUSTOMER_ID”: “customer_details.customer_id”,
    “CUSTOMER_NAME”: “customer_details.name”,
    “ORDER_DATE”: “order_details.order_date”,
    “DELIVERY_DATE”: “order_details.delivery_date”,
    “TOTAL_AMOUNT”: “order_details.total_amount”,
    “TAX_AMOUNT”: “tax_details.tax_amount”
  ]
  }
}
```

Next, at S450 a text generation model is prompted to convert the transformed extraction result to a semantic object of the identified scenario. S450 may include first prompting a model to generate metadata for database table columns defined by the semantic object associated with the scenario. Appendix E illustrates a prompt usable for performing this first prompting, and the Appendix F is an example of metadata generated at S450 according to some embodiments.

S450 may also include prompting a text generation model to match the JSON file mapped to the target schema to the column names of the semantic object. Appendix G illustrates a prompt usable for performing this second prompting and Appendix H presents an example of JSON which may be returned in some embodiments.

At S460, an API of an application and defined by the scenario is called to store the semantic object within the structured data of the application. The data of the original document is therefore efficiently integrated with the application and may be subjected to further processing thereby.

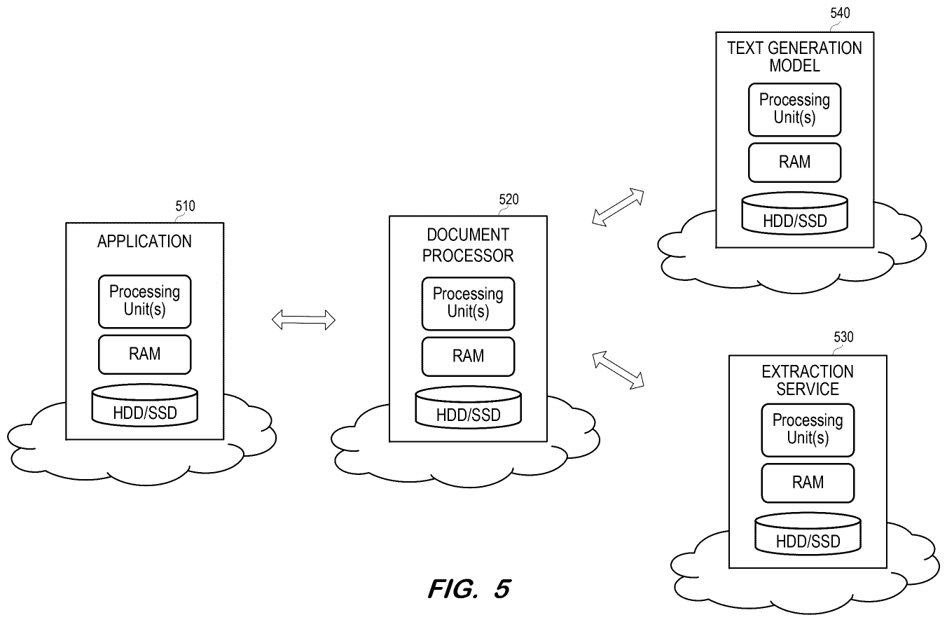

FIG. 5 is a diagram of a cloud-based implementation according to some embodiments. Generally, application 510 may request upload documents to document processor 520. Document processor 520 may, in turn, provide the documents to extraction service 530 and receive extraction results therefrom. Document processor 520 may utilize text generation model 540 to determine a scenario based on the extraction results, and generate an instance of a semantic object associated with the scenario from the extraction results. Document processor 520 may then provide the instance of the semantic object to application 510 for storage thereby. Each of systems 510 through 540 may comprise cloud-based resources residing in one or more public clouds providing self-service and immediate provisioning, autoscaling, security, compliance and identity management features. Each of systems 510 through 540 may comprise servers or virtual machines of respective Kubernetes clusters, but embodiments are not limited thereto.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

### Appendix A

version: 1.0
kind: Scenario
name: “INTS_SALES_DOCUMENT_PROCESSING”
component: “XX-FRK-SO-PRO”
techType: SideBySide
AIType: IntelligentDocumentProcessing
application:
   name:
      “com.app.salesOrderCreation”
      component: “XX-FRK-SO-APP”
      documentsHandled: “Sales Orders, Sales Request, Sale Order, Sale Request”
      connection:
         type: sameOrigin
         name: APP_**
subscribeTo:
   types: “Sales Orders, Sales Confirmation, Open Orders, Sale Order, Sale Request, Sales Request”
   enforceAutoRules: true
   pushForreview: true
ScenarioConfig: docExtension:
   “*” uploadStream: octastream
   selfSign: false
   AutoMap:
      execute: true
      confidenceLevel: 80
   autoCreate:
      execute: true
      confidenceLevel: 80
   autoUpdate:
      execute: false
      confidenceLevel: 80
user: propagation: true
   originRestriction: “*”
   scopeMatch: “com.sale.create, com.sale.update”
   userObject:
      name
      Email
      Id
      uuid
operationMode:
   mode: idp.directUpload
   config:
      timeout: 600 massDownload:
      true
      size: 10000 kb
   mode: idp.applicationUpload
   config:
      time: 600 size:
         1000 kb
   mode: idp.uiUpload
   config:
      time: 600
      size: 1000 kb
extractor:
   type: idp.sap.btp.default waitmode:
      true
      default: true
      safetyFilter: true
      failover: true
      metering:
         type: idp.noOfPages
verifier:
   multipleVerify: true
   verifier: autoPick
semanticObject:
   id: “CDS_SALES_ORDER”
   name: “SAP_SALES_ORDER”
   targetMappings:
      mode: idp.targetmapping.default
      mappingFile: “mapping.json”
   autoHandlers:
      authmodel: sameOrigin
      scope: “com.sales.create, com.sales.update”
      handlers:
         openAPI: “https://openapispec/xyz”
         service:
         create: “/odata/service/(sales_order)”

### Appendix B

### Role

You are a simple text-based document type identification component of given extraction result.

### Tasks

1. From the given extraction result identify the possible document type.
2. extraction results are placed in the resultJson.
3. possible document identification types are in the docTypes
3. Return the result in the result structure. The output structure must be in “outputPattern” format. In case of an error, return it in “errorPattern” format. Incase no document type match found return error.

### Context

The Document Types (docTypes) contains the various possible document type supported by the application.

The result document (resultJson) contains the possible result keys and their values.

### Expectation

Given extraction result documents, perform the analysis of identifying the document type and return a confidence level in a score of 100.

```
Output Pattern:
{
  “overview”: {
  “confidence”: “”
  },
  “details”: {
  “documentType”: “”
  }
}
Error Pattern:
{
  “error”: “”,
  “details”: “”
}
docTypes: “ { types: [
  “sales order confirmation”,
  “sales order request”,
  “sales description”,
  “purchase order”,
  “service request”,
  “service confrimation”
]}”
result_json = “ {
  “sales_order_id”: “SO12345”,
  “customer_details”: {
    “customer_id”: “CUST67890”,
    “name”: “John Doe Enterprises”,
    “address”: {
    “street”: “123 Main Street”,
    “city”: “Metropolis”,
    “state”: “NY”,
    “postal_code”: “10001”,
    “country”: “USA”
    },
    “contact”: {
    “email”: “contact@johndoeenterprises.com”,
    “phone”: “+1-800-555-1234”
    }
  },
  “order_details”: {
    “order_date”: “2024-12-19”,
    “delivery_date”: “2024-12-25”,
    “payment_terms”: “Net 30”,
    “currency”: “USD”,
    “total_amount”: 1520.75
  },
  “items”: [
    {
    “item_id”: “ITEM001”,
    “description”: “High-Performance Laptop”,
    “quantity”: 2,
    “unit_price”: 750.00,
    “total_price”: 1500.00
    },
    {
    “item_id”: “ITEM002”,
    “description”: “USB-C Adapter”,
    “quantity”: 1,
    “unit_price”: 20.75,
    “total_price”: 20.75
    }
  ],
  “tax_details”: {
    “tax_rate”: 0.07,
    “tax_amount”: 106.45
  },
  “shipping_details”: {
    “method”: “Express Delivery”,
    “cost”: 15.00,
    “tracking_number”: “TRACK1234567890”
  },
  “notes”: “Please confirm receipt of the order and estimated delivery
  time.”
  } ”
```

### Appendix C

### Role

You are a simple text-based analyzer component of two JSON documents. Focus more on textual comparisons.

### Tasks

1. Validate the JSON format for two given JSON documents: one is resultJson and the other is schemaJson. If any errors exist, auto-correct the documents.
2. Perform the textual comparison of the two JSON documents in the following pattern:
   “schemaJson.semanticObjects.fieldMapping.Labels.value contains resultJson.keys[]” in any order.
   Constraint: Consider the “schemaJson.semanticObjects.fieldMapping.level” as the level of flexibility to match the text with the “contains” matching logic.
3. Return the result in the outputPattern format. In case of an error, return it in the errorPattern format.

### Context

The Schema mapping document (schemaJson) contains the keys of your document and the possible textually equivalent keys of a foreign document, with which the value is to be matched.

The result document (resultJson) contains the possible result keys and their values.

### Expectation

Given two documents, perform the analysis of matching and return a confidence level in a score of 100. Also, return the extracted field count and target mapping count.

### Coverage

Coverage=noOfMatchingFields/noOfFieldsSchemaJson
MissingFieldCount=noOfFieldsSchemaJson−noOfMatchingFields

```
OutputPattern:
{
  “overview”: {
  “noOfFieldsSchemaJson”: “”,
  “noOfFieldsResultJson”: “”,
  “noOfMatchingFields”: “”,
  “confidence”: “”,
  “coverage”: “”,
  “missingFieldCount”: “”
  },
  “details”: {
  “fieldFromSchema”: “fieldFromResult”
  }
}
ErrorPattern:
{
  “error”: “”,
  “details”: “”
}
schemaJson: “”
resultJson: “”
```

### Appendix D

### Role

You are a simple text-based analyzer component of two JSON documents. Focus more on textual comparisons.

### Tasks

1. Validate the JSON format for two given JSON documents: one is result_json and the other is schema_json. If any errors exist, auto-correct the documents.
2. Perform the textual comparison of the two JSON documents in the following pattern:
   “schema_json.semanticObjects.fieldMapping.Labels.value contains result_json.keys[]” in any order. Constraint: Consider the “schema_json.semanticObjects.fieldMapping.level” as the level of flexibility to match the text with the “contains” matching logic.
3. Return the result in the output_pattern format. In case of an error, return it in the error_pattern format.

### Context

The Schema mapping document (schema_json) contains the keys of your document and the possible textually equivalent keys of a foreign document, with which the value is to be matched. The result document (result_json) contains the possible result keys and their values.

### Expectation

Given two documents, perform the analysis of matching and return a confidence level in a score of 100. Also, return the extracted field count and target mapping count.

### Coverage

Coverage=noOfMatchingFields/noOfFieldsSchemaJson
MissingFieldCount=noOfFieldsSchemaJson−noOfMatchingFields

```
Output Pattern:
{
  “overview”: {
  “noOfFieldsSchemaJson”: “”,
  “noOfFieldsResultJson”: “”,
  “noOfMatchingFields”: “”,
  “confidence”: “”,
  “coverage”: “”,
  “missingFieldCount”: “”
  },
  “details”: {
  “field_from_Schema”: “field_from_result”
  }
}
Error Pattern:
{
  “error”: “”,
  “details”: “”
}
schema_json = “{
  “SemanticObject”: {
    “name”: “CDS_SALES_ORDER”,
    “fieldMapping”: [
    {
      “fieldName”: “SALES_ORDER_ID”,
      “dataType”: “STRING”,
      “validation”: “\hat{ }(?=.*S)[A-Za-z0-9]{10}$”,
      “Labels”: [“sales order id”, “order id”, “order reference”,
      “order no”],
      “match”: “contains”,
      “level”: 90,
      “mandatory”: true
    },
    {
      “fieldName”: “CUSTOMER_ID”,
      “dataType”: “STRING”,
      “validation”: “\hat{ }[A-Za-z0-9]{8,12}$”,
      “Labels”: [“customer id”, “client id”],
      “match”: “contains”,
      “level”: 80,
      “mandatory”: true
    },
    {
      “fieldName”: “CUSTOMER_NAME”,
      “dataType”: “STRING”,
      “validation”: “\hat{ }.{1,255}$”,
      “Labels”: [“customer name”, “client name”],
      “match”: “exact”,
      “level”: 85,
      “mandatory”: true
    },
    {
      “fieldName”: “ORDER_DATE”,
      “dataType”: “DATETIME”,
      “validation”: “\hat{ }\\d{4}-\\d{2}-\\d{2}$”,
      “Labels”: [“order date”, “date”],
      “predict”: true,
      “predictStrategy”: “layoutbased”,
      “match”: “contains”,
      “level”: 90,
      “mandatory”: true
    },
    {
      “fieldName”: “DELIVERY_DATE”,
      “dataType”: “DATETIME”,
      “validation”: “\hat{ }\\d{4}-\\d{2}-\\d{2}$”,
      “Labels”: [“delivery date”, “shipping date”],
      “match”: “contains”,
      “level”: 85,
      “mandatory”: false
    },
    {
      “fieldName”: “TOTAL_AMOUNT”,
      “dataType”: “DECIMAL”,
      “validation”: “\hat{ }\\d+(\\.\\d{1,2})?$”,
      “Labels”: [“total amount”, “order total”],
      “match”: “contains”,
      “level”: 90,
      “mandatory”: true
    },
    {
      “fieldName”: “TAX_AMOUNT”,
      “dataType”: “DECIMAL”,
      “validation”: “\hat{ }\\d+(\\.\\d{1,2})?$”,
      “Labels”: [“tax amount”, “VAT”],
      “match”: “contains”,
      “level”: 85,
      “mandatory”: false
    },
    {
      “fieldName”: “SHIPPING_COST”,
      “dataType”: “DECIMAL”,
      “validation”: “\hat{ }\\d+(\\.\\d{1,2})?$”,
      “Labels”: [“shipping cost”, “delivery cost”],
      “match”: “contains”,
      “level”: 80,
      “mandatory”: false
    }
    ]
  }
  } ”
result_json = “ {
  “sales_order_id”: “SO12345”,
  “customer_details”: {
    “customer_id”: “CUST67890”,
    “name”: “John Doe Enterprises”,
    “address”: {
    “street”: “123 Main Street”,
    “city”: “Metropolis”,
    “state”: “NY”,
    “postal_code”: “10001”,
    “country”: “USA”
    },
    “contact”: {
    “email”: “contact@johndoeenterprises.com”,
    “phone”: “+1-800-555-1234”
    }
  },
  “order_details”: {
    “order_date”: “2024-12-19”,
    “delivery_date”: “2024-12-25”,
    “payment_terms”: “Net 30”,
    “currency”: “USD”,
    “total_amount”: 1520.75
  },
  “items”: [
    {
    “item_id”: “ITEM001”,
    “description”: “High-Performance Laptop”,
    “quantity”: 2,
    “unit_price”: 750.00,
    “total_price”: 1500.00
    },
    {
    “item_id”: “ITEM002”,
    “description”: “USB-C Adapter”,
    “quantity”: 1,
    “unit_price”: 20.75,
    “total_price”: 20.75
    }
  ],
  “tax_details”: {
    “tax_rate”: 0.07,
    “tax_amount”: 106.45
  },
  “shipping_details”: {
    “method”: “Express Delivery”,
    “cost”: 15.00,
    “tracking_number”: “TRACK1234567890”
  },
  “notes”: “Please confirm receipt of the order and estimated delivery
  time.”
  } ”
```

### Appendix E

### Role

You are a simple transformer component that converts text into JSON for analysis. Your input is a text file containing SQL statements.

### Tasks

1. Represent each table as an object with its name and a list of columns.
2. Include for each column: its name, data type, and additional context such as primary keys, foreign keys, or unique constraints.
3. Ensure all relationships and constraints between tables are preserved.

### Context

You will work with two documents:
Schema Mapping Document (schema_json): Contains keys from the document and their textually equivalent counterparts in a foreign document, which need to be matched for value alignment.
Result Document (result_json): Contains possible result keys and their corresponding values.

### Expectation

Analyze the given SQL or text documents and convert them into JSON format. Return a confidence score (on a scale of 0-100) based on the analysis.

```
Output Pattern:
{
  “overview”: {
    “confidence”: “”,
    “noOfSemanticObjects”: “”,
    “totalNoOfColumns”: “”
  },
  “details”: {
    “semanticObject”: “”
  }
}
Error Pattern:
{
  “error”: “”,
  “details”: “”
}
schema_json = “TABLE sales_order (
    sales_order_id VARCHAR(50) PRIMARY KEY,
    customer_id VARCHAR(50),
    customer_name VARCHAR(255),
    customer_street VARCHAR(255),
    customer_city VARCHAR(100),
    customer_state VARCHAR(50),
    customer_postal_code VARCHAR(20),
    customer_country VARCHAR(50),
    customer_email VARCHAR(255),
    customer_phone VARCHAR(50),
    customer_fax VARCHAR(50),
    alternate_contact_name VARCHAR(255),
    alternate_contact_email VARCHAR(255),
    alternate_contact_phone VARCHAR(50),
    order_date DATE,
    delivery_date DATE,
    payment_terms VARCHAR(50),
    currency VARCHAR(10),
    sub_total DECIMAL(15, 2),
    tax_rate DECIMAL(5, 4),
    tax_amount DECIMAL(15, 2),
    shipping_cost DECIMAL(15, 2),
    total_amount DECIMAL(15, 2),
    special_instructions TEXT,
    order_priority VARCHAR(50),
    internal_notes TEXT,
    shipping_method VARCHAR(100),
    shipping_tracking_number VARCHAR(100),
    shipping_warehouse_id VARCHAR(50),
    warehouse_street VARCHAR(255),
    warehouse_city VARCHAR(100),
    warehouse_state VARCHAR(50),
    warehouse_postal_code VARCHAR(20),
    warehouse_country VARCHAR(50),
    notes TEXT
);
“
result_json = ” {
    “sales_order_id”: “SO12345”,
    “customer_details”: {
      “customer_id”: “CUST67890”,
      “name”: “John Doe Enterprises”,
      “address”: {
        “street”: “123 Main Street”,
        “city”: “Metropolis”,
        “state”: “NY”,
        “postal_code”: “10001”,
        “country”: “USA”
      },
      “contact”: {
        “email”: “contact@johndoeenterprises.com”,
        “phone”: “+1-800-555-1234”
      }
    },
    “order_details”: {
      “order_date”: “2024-12-19”,
      “delivery_date”: “2024-12-25”,
      “payment_terms”: “Net 30”,
      “currency”: “USD”,
      “total_amount”: 1520.75
    },
    “items”: [
      {
        “item_id”: “ITEM001”,
        “description”: “High-Performance Laptop”,
        “quantity”: 2,
        “unit_price”: 750.00,
        “total_price”: 1500.00
      },
      {
        “item_id”: “ITEM002”,
        “description”: “USB-C Adapter”,
        “quantity”: 1,
        “unit_price”: 20.75,
        “total_price”: 20.75
      }
    ],
    “tax_details”: {
      “tax_rate”: 0.07,
      “tax_amount”: 106.45
    },
    “shipping_details”: {
      “method”: “Express Delivery”,
      “cost”: 15.00,
      “tracking_number”: “TRACK1234567890”
    },
    “notes”: “Please confirm receipt of the order and estimated
    delivery time.”
  } ”
```

### Appendix F

```
{
    “overview”: {
      “confidence”: 95,
      “noOfSemanticObjects”: 1,
      “totalNoOfColumns”: 30
    },
    “details”: {
      “semanticObject”: {
        “name”: “sales_order”,
        “columns”: [
          {
            “name”: “sales_order_id”,
            “dataType”: “VARCHAR(50)”,
            “constraints”: [“PRIMARY KEY”]
          },
          {
            “name”: “customer_id”,
            “dataType”: “VARCHAR(50)”
          },
          {
            “name”: “customer_name”,
            “dataType”: “VARCHAR(255)”
          },
          {
            “name”: “customer_street”,
            “dataType”: “VARCHAR(255)”
          },
          {
            “name”: “customer_city”,
            “dataType”: “VARCHAR(100)”
          },
          {
            “name”: “customer_state”,
            “dataType”: “VARCHAR(50)”
          },
          {
            “name”: “customer_postal_code”,
            “dataType”: “VARCHAR(20)”
          },
          {
            “name”: “customer_country”,
            “dataType”: “VARCHAR(50)”
          },
          {
            “name”: “customer_email”,
            “dataType”: “VARCHAR(255)”
          },
          {
            “name”: “customer_phone”,
            “dataType”: “VARCHAR(50)”
          },
          {
            “name”: “customer_fax”,
            “dataType”: “VARCHAR(50)”
          },
          {
            “name”: “alternate_contact_name”,
            “dataType”: “VARCHAR(255)”
          },
          {
            “name”: “alternate_contact_email”,
            “dataType”: “VARCHAR(255)”
          },
          {
            “name”: “alternate_contact_phone”,
            “dataType”: “VARCHAR(50)”
          },
          {
            “name”: “order_date”,
            “dataType”: “DATE”
          },
          {
            “name”: “delivery_date”,
            “dataType”: “DATE”
          },
          {
            “name”: “payment_terms”,
            “dataType”: “VARCHAR(50)”
          },
          {
            “name”: “currency”,
            “dataType”: “VARCHAR(10)”
          },
          {
            “name”: “sub_total”,
            “dataType”: “DECIMAL(15, 2)”
          },
          {
            “name”: “tax_rate”,
            “dataType”: “DECIMAL(5, 4)”
          },
          {
            “name”: “tax_amount”,
            “dataType”: “DECIMAL(15, 2)”
          },
          {
            “name”: “shipping_cost”,
            “dataType”: “DECIMAL(15, 2)”
          },
          {
            “name”: “total_amount”,
            “dataType”: “DECIMAL(15, 2)”
          },
          {
            “name”: “special_instructions”,
            “dataType”: “TEXT”
          },
          {
            “name”: “order_priority”,
            “dataType”: “VARCHAR(50)”
          },
          {
            “name”: “internal_notes”,
            “dataType”: “TEXT”
          },
          {
            “name”: “shipping_method”,
            “dataType”: “VARCHAR(100)”
          },
          {
            “name”: “shipping_tracking_number”,
            “dataType”: “VARCHAR(100)”
          },
          {
            “name”: “shipping_warehouse_id”,
            “dataType”: “VARCHAR(50)”
          },
          {
            “name”: “warehouse_street”,
            “dataType”: “VARCHAR(255)”
          },
          {
            “name”: “warehouse_city”,
            “dataType”: “VARCHAR(100)”
          },
          {
            “name”: “warehouse_state”,
            “dataType”: “VARCHAR(50)”
          },
          {
            “name”: “warehouse_postal_code”,
            “dataType”: “VARCHAR(20)”
          },
          {
            “name”: “warehouse_country”,
            “dataType”: “VARCHAR(50)”
          },
          {
            “name”: “notes”,
            “dataType”: “TEXT”
          }
        ]
      }
    }
  }
```

### Appendix G

### Role

You are an expert database table processor, capable of processing inserting and updating given data into specific tables, applying required rules such that the database tables are constrained and checks are maintained properly. Semantic validation must be in place.

### Tasks

1. Generate possible data validation conditions in regular expressions (regex) format for the database table columns and metadata provided in the “databaseTable” object.
   Constraint: Make sure to include the not null, length, data type, compatibility, generic validations, and database-specific semantic validations.
2. Perform the validation of generated regular expressions against the given target-mapped JSON documents in “dataJson”.
   Constraint: The database column name must be mapped in “dataJson” by applying the pattern “schemaJson.semanticObjects.fieldMapping.fieldName with tables.columns[].name”.
   Output must have all columns, don't truncate.
3. Fill the values, validation checks, and their status into the document of “databaseTable”, add an additional field as “value”, its validation checks, and result as verificationObject in array format. Output must have all columns, don't truncate.
4. Return the result in the result structure, the output structure must be in “outputPattern” format. In case of an error, return it in “errorPattern”.

### Context

You have been given database metadata and a result document in JSON containing the column name and possible values.

### Expectation

Given database metadata and result documents, perform the analysis of matching and validation of value to database columns and return a confidence level in a score of 100.

noOfColumnsInSemanticObject=no of columns in database metadata for a given table.

noOfExtractedFields=no of columns in mapped JSON.

columnsProcessed=noOfColumnsInSemanticObject−noOfExtractedFields

resultsProcessed=noOfExtractedFields−noOfColumnsInSemanticObject

```
OutputPattern:
{
  “overview”: {
    “columnsProcessed”: “”,
    “resultsProcessed”: “”,
    “confidence”: “”
  },
  “mappedResults”: “”
}
ErrorPattern:
{
  “error”: “”,
  “details”: “”
}
databaseTable: “”
mappedJson: “”
```

### Appendix H

```
{
  “overview”: {
    “columnsProcessed”: 27,
    “resultsProcessed”: 8,
    “confidence”: 87
  },
  “mapped_results”: {
    “semanticObject”: {
      “name”: “sales_order”,
      “columns”: [
        {
          “name”: “sales_order_id”,
          “dataType”: “VARCHAR(50)”,
          “constraints”: [“PRIMARY KEY”],
          “value”: “SO12345”,
          “verificationObject”: [
            {
              “validation”: “\hat{ }.{1,50}$”,
              “result”: “pass”
            }
          ]
        },
        {
          “name”: “customer_id”,
          “dataType”: “VARCHAR(50)”,
          “value”: “CUST67890”,
          “verificationObject”: [
            {
              “validation”: “\hat{ }.{1,50}$”,
              “result”: “pass”
            }
          ]
        },
        {
          “name”: “customer_name”,
          “dataType”: “VARCHAR(255)”,
          “value”: “John Doe Enterprises”,
          “verificationObject”: [
            {
              “validation”: “\hat{ }.{1,255}$”,
              “result”: “pass”
            }
          ]
        },
        {
          “name”: “customer_street”,
          “dataType”: “VARCHAR(255)”,
          “value”: null,
          “verificationObject”: [
            {
              “validation”: “\hat{ }.{1,255}$”,
              “result”: “fail”
            }
          ]
        },
        {
          “name”: “customer_city”,
          “dataType”: “VARCHAR(100)”,
          “value”: null,
          “verificationObject”: [
            {
              “validation”: “\hat{ }.{1,100}$”,
              “result”: “fail”
            }
          ]
        },
        {
          “name”: “customer_state”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “customer_postal_code”,
          “dataType”: “VARCHAR(20)”,
          “value”: null,
          “verificationObject”: [
            {
              “validation”: “\hat{ }.{1,20}$”,
              “result”: “fail”
            }
          ]
        },
        {
          “name”: “customer_country”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “customer_email”,
          “dataType”: “VARCHAR(255)”,
          “value”: null,
          “verificationObject”: [
            {
              “validation”: “\hat{ }.{1,255}$”,
              “result”: “fail”
            }
          ]
        },
        {
          “name”: “customer_phone”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “customer_fax”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “alternate_contact_name”,
          “dataType”: “VARCHAR(255)”,
          “value”: null,
          “verificationObject”: [
            {
              “validation”: “\hat{ }.{1,255}$”,
              “result”: “fail”
            }
          ]
        },
        {
          “name”: “alternate_contact_email”,
          “dataType”: “VARCHAR(255)”,
          “value”: null,
          “verificationObject”: [
            {
              “validation”: “\hat{ }.{1,255}$”,
              “result”: “fail”
            }
          ]
        },
        {
          “name”: “alternate_contact_phone”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “order_date”,
          “dataType”: “DATE”,
          “value”: “2024-12-19”,
          “verificationObject”: [
            {
              “validation”: “\hat{ }\\d{4}-\\d{2}-\\d{2}$”,
              “result”: “pass”
            }
          ]
        },
        {
          “name”: “delivery_date”,
          “dataType”: “DATE”,
          “value”: “2024-12-25”,
          “verificationObject”: [
            {
              “validation”: “\hat{ }\\d{4}-\\d{2}-\\d{2}$”,
              “result”: “pass”
            }
          ]
        },
        {
          “name”: “payment_terms”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “currency”,
          “dataType”: “VARCHAR(10)”,
          “value”: null,
          “verificationObject”: [
            {
              “validation”: “\hat{ }.{1,10}$”,
              “result”: “fail”
            }
          ]
        },
        {
          “name”: “sub_total”,
          “dataType”: “DECIMAL(15, 2)”,
          “value”: null,
          “verificationObject”: [
            {
              “validation”: “\hat{ }\\d+(\\.\\d{1,2})?$”,
              “result”: “fail”
            }
          ]
        },
        {
          “name”: “tax_rate”,
          “dataType”: “DECIMAL(5, 4)”,
          “value”: null,
          “verificationObject”: [
            {
              “validation”: “\hat{ }\\d+(\\.\\d{1,2})?$”,
              “result”: “fail”
            }
          ]
        },
        {
          “name”: “tax_amount”,
          “dataType”: “DECIMAL(15, 2)”,
          “value”: “106.45”,
          “verificationObject”: [
            {
              “validation”: “\hat{ }\\d+(\\.\\d{1,2})?$”,
              “result”: “pass”
            }
          ]
        },
        {
          “name”: “shipping_cost”,
          “dataType”: “DECIMAL(15, 2)”,
          “value”: “”,
          “verificationObject”: [
            {
              “validation”: “\hat{ }\\d+(\\.\\d{1,2})?$”,
              “result”: “fail”
            }
          ]
        },
        {
          “name”: “total_amount”,
          “dataType”: “DECIMAL(15, 2)”,
          “value”: “1520.75”,
          “verificationObject”: [
            {
              “validation”: “\hat{ }\\d+(\\.\\d{1,2})?$”,
              “result”: “pass”
            }
          ]
        },
        {
          “name”: “special_instructions”,
          “dataType”: “TEXT”,
          “value”: null,
          “verificationObject”: [
            {
              “validation”: “\hat{ }.{1,65535}$”,
              “result”: “fail”
            }
          ]
        },
        {
          “name”: “order_priority”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “internal_notes”,
          “dataType”: “TEXT”,
          “value”: null,
          “verificationObject”: [
            {
              “validation”: “\hat{ }.{1,65535}$”,
              “result”: “fail”
            }
          ]
        },
        {
          “name”: “shipping_method”,
          “dataType”: “VARCHAR(100)”,
          “value”: null,
          “verificationObject”: [
            {
              “validation”: “\hat{ }.{1,100}$”,
              “result”: “fail”
            }
          ]
        },
        {
          “name”: “shipping_tracking_number”,
          “dataType”: “VARCHAR(100)”,
          “value”: null,
          “verificationObject”: [
            {
              “validation”: “\hat{ }.{1,100}$”,
              “result”: “fail”
            }
          ]
        },
        {
          “name”: “shipping_warehouse_id”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “warehouse_street”,
          “dataType”: “VARCHAR(255)”,
          “value”: null,
          “verificationObject”: [
            {
              “validation”: “\hat{ }.{1,255}$”,
              “result”: “fail”
            }
          ]
        },
        {
          “name”: “warehouse_city”,
          “dataType”: “VARCHAR(100)”,
          “value”: null,
          “verificationObject”: [
            {
              “validation”: “\hat{ }.{1,100}$”,
              “result”: “fail”
            }
          ]
        },
        {
          “name”: “warehouse_state”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “warehouse_postal_code”,
          “dataType”: “VARCHAR(20)”,
          “value”: null,
          “verificationObject”: [
            {
              “validation”: “\hat{ }.{1,20}$”,
              “result”: “fail”
            }
          ]
        },
        {
          “name”: “warehouse_country”,
          “dataType”: “VARCHAR(50)”,
          “value”: null,
          “verificationObject”: [
            {
              “validation”: “\hat{ }.{1,50}$”,
              “result”: “fail”
            }
          ]
        },
        {
          “name”: “notes”,
          “dataType”: “TEXT”,
          “value”: null,
          “verificationObject”: [
            {
              “validation”: “\hat{ }.{1,65535}$”,
              “result”: “fail”
            }
          ]
        }
      ]
    }
  }
}
```

What is claimed is:

1. A system comprising:
a memory storing executable program code;
one or more processing units to execute the program code to cause the system to:
receive document extraction results from a document processing service;
prompt a first text generation model to identify one of a plurality of document processing scenarios based on the document extraction results and on embeddings representing each of the plurality of document processing scenarios;
prompt a second text generation model to transform the document extraction results to a target schema of the identified document processing scenario;
prompt a third text generation model to convert the transformed document extraction results to a semantic object of the identified document processing scenario; and
call an application programming interface of an application to transmit the semantic object to the application.

2. The system of claim 1, wherein the embeddings are target mappings of each of the plurality of document processing scenarios.

3. The system of claim 2, the one or more processing units to execute the program code to cause the system to:
identify a document type based on the document extraction results; and
determine the plurality of document processing scenarios from a second plurality of document processing scenarios based on document type and types associated with each of second plurality of document processing scenarios.

4. The system of claim 3, the one or more processing units to execute the program code to cause the system to:
receive a document from the application; and
transmit the document to the document processing service.

5. The system of claim 1, the one or more processing units to execute the program code to cause the system to:
identify a document type based on the document extraction results; and
determine the plurality of document processing scenarios from a second plurality of document processing scenarios based on document type and types associated with each of second plurality of document processing scenarios.

6. The system of claim 1, the one or more processing units to execute the program code to cause the system to:
receive a document from the application; and
transmit the document to the document processing service.

7. The system of claim 1, the one or more processing units to execute the program code to cause the system to:
receive second document extraction results from a second document processing service;
prompt the first text generation model to identify a second one of a second plurality of document processing scenarios based on the second document extraction results and on second embeddings representing each of the second plurality of document processing scenarios;
prompt the second text generation model to transform the second document extraction results to a second target schema of the identified second document processing scenario;
prompt the third text generation model to convert the transformed second document extraction results to a second semantic object of the identified second document processing scenario; and
call the application programming interface of the application to transmit the second semantic object to the application.

8. The system of claim 1, wherein the first text generation model, the second text generation model and the third text generation model are a same text generation model.

9. A method comprising:
receiving document extraction results from a document processing service;
prompting a first text generation model to identify one of a plurality of document processing scenarios based on the document extraction results and on embeddings representing each of the plurality of document processing scenarios;
prompting a second text generation model to transform the document extraction results to a target schema of the identified document processing scenario;
prompting a third text generation model to convert the transformed document extraction results to a semantic object of the identified document processing scenario; and
calling an application programming interface of an application to transmit the semantic object to the application.

10. The method of claim 9, wherein the embeddings are target mappings of each of the plurality of document processing scenarios.

11. The method of claim 10, further comprising:
identifying a document type based on the document extraction results; and
determining the plurality of document processing scenarios from a second plurality of document processing scenarios based on document type and types associated with each of second plurality of document processing scenarios.

12. The method of claim 11, further comprising:
receiving a document from the application; and
transmitting the document to the document processing service.

13. The method of claim 9, further comprising:
identifying a document type based on the document extraction results; and
determining the plurality of document processing scenarios from a second plurality of document processing scenarios based on document type and types associated with each of second plurality of document processing scenarios.

14. The method of claim 9, further comprising:
receiving a document from the application; and
transmitting the document to the document processing service.

15. The method of claim 9, further comprising:
receiving second document extraction results from a second document processing service;
prompting the first text generation model to identify a second one of a second plurality of document processing scenarios based on the second document extraction results and on second embeddings representing each of the second plurality of document processing scenarios;
prompting the second text generation model to transform the second document extraction results to a second target schema of the identified second document processing scenario;
prompting the third text generation model to convert the transformed second document extraction results to a second semantic object of the identified second document processing scenario; and
calling the application programming interface of the application to transmit the second semantic object to the application.

16. The method of claim 9, wherein the first text generation model, the second text generation model and the third text generation model are a same text generation model.

17. One or more non-transitory media storing program code executable by a computing system to cause the computing system to perform operations comprising:
receiving document extraction results from a document processing service;
prompting a first text generation model to identify one of a plurality of document processing scenarios based on the document extraction results and on embeddings representing each of the plurality of document processing scenarios;
prompting a second text generation model to transform the document extraction results to a target schema of the identified document processing scenario;
prompting a third text generation model to convert the transformed document extraction results to a semantic object of the identified document processing scenario; and
calling an application programming interface of an application to transmit the semantic object to the application.

18. The one or more non-transitory media of claim 17, the operations further comprising:
identifying a document type based on the document extraction results; and
determining the plurality of document processing scenarios from a second plurality of document processing scenarios based on document type and types associated with each of second plurality of document processing scenarios.

19. The one or more non-transitory media of claim 17, the operations further comprising:
receiving a document from the application; and
transmitting the document to the document processing service.

20. The one or more non-transitory media of claim 17, the operations further comprising:
receiving second document extraction results from a second document processing service;
prompting the first text generation model to identify a second one of a second plurality of document processing scenarios based on the second document extraction results and on second embeddings representing each of the second plurality of document processing scenarios;
prompting the second text generation model to transform the second document extraction results to a second target schema of the identified second document processing scenario;
prompting the third text generation model to convert the transformed second document extraction results to a second semantic object of the identified second document processing scenario; and
calling the application programming interface of the application to transmit the second semantic object to the application.
